(19) United States
(12) Patent Application Publication
(10) Pub. No.: US 2015/0210968 A1
(43) Pub. Date: Jul. 30, 2015

(54) LIQUID DETERGENT COMPOSITION

(71) Applicant: Givaudan, S.A., Vernier (CH)

(72) Inventors: Adriana LOPES SCHIOZER, Valinhos (BR); Mario Jovelino DEL NUNZIO, Jacareí (BR)

(21) Appl. No.: 14/677,163

(22) Filed: Apr. 2, 2015

Related U.S. Application Data
(63) Continuation of application No. 14/349,232, filed on Apr. 2, 2014.

(30) Foreign Application Priority Data
Oct. 6, 2011 (GB) 1117231.9

(51) Int. Cl. C11D 17/00; C11D 3/37; C11D 3/12

(52) U.S. Cl. CPC C11D 17/0039; C11D 3/1266; C11D 3/3765

(57) ABSTRACT

A liquid detergent composition including a liquid detergent composition base and active-containing capsules of 200 μM diameter maximum, characterised in that the base has a pH of from 7-11 and additionally contains a suspension agent, which includes a combination of a hydrophilic clay and a polymeric thickening agent, which thickening agent is an alkali metal salt of a polycarboxylic acid. The capsules remain uniformly dispersed in the composition for long periods, thus allowing the benefit of the active to be retained for the life of the composition.

The present application is a continuation of co-pending U.S. Ser. No. 14/349,232, having a 371(c) date of Apr. 2, 2014, which is a national stage application of International Application No. PCT/EP2012/069831, filed on Oct. 8, 2012, which claims priority from Great Britain Patent Application No. 1117231.9, filed on Oct. 6, 2011, and which are incorporated herein by reference.

This disclosure relates to liquid detergent compositions containing active capsules.

It has been desired to disperse active-containing capsules in liquid detergent compositions such as heavy duty liquid detergents (HDLD), light duty liquid detergents (LDLD). By “active” is meant at least one substance whose presence is ultimately desired in the compositions, but at a time point later than the mixing of the various ingredients to form the composition. A typical active is perfume. The idea is that the active will be preserved in the composition until it is needed, and at some point it will be released, for example, by the action of washing fabrics. The mechanism by which the active is released will depend on the nature of the capsule, for example, by breakage or diffusion. Capsules capable of doing this have been known and used for some time, and there is an extensive literature on the sublet.

However, one of the difficulties of dealing with capsules is to ensure that they remain essentially uniformly dispersed throughout the composition. It is not desirable that they either all float to the top or sink to the bottom of the composition. Because they are relatively light and comparatively large in comparison with other particles that may be present in such compositions, this has hitherto been difficult to realise.

The obvious solution is to ensure that the capsules and the liquid formulation in which they are dispersed have equal densities. However, it is practically impossible to ensure an exact density match, and over long storage times, most of the capsules will either float or sink. An alternative is to modify the viscosity of the liquid formulation, by adding a suitable compound. Many of these are commercially available, and they include such materials as polymer emulsions, ionic polymers, cellulose derivatives and various types of hydrophilic clays. However, making the microcapsules desirably stable in such a composition generally involves making the composition so viscous that it no longer pours acceptably.

It has now been found that it is possible to prepare a liquid detergent composition in which capsules containing an active ingredient may be stably suspended for long periods. There is therefore provided a liquid detergent composition comprising a liquid detergent composition base and active-containing capsules of 200 μm diameter maximum, characterised in that the base has a pH of from 7-11, particularly from 7-10 and more particularly from 8-9, and additionally contains a suspension agent, which comprises a combination of a hydrophilic clay and a polymeric thickening agent, which thickening agent is an alkali metal salt of a polycarboxylic acid.

There is further provided a method of making a microcapsule-containing liquid detergent composition, comprising the addition to a liquid detergent base of active-containing microcapsules; characterised in that:
(a) there is first added to the base a polymeric thickening agent, which polymeric thickening agent is an alkali metal salt of a polycarboxylic acid;
(b) the pH is adjusted to a value of from 7-11, particularly from 7-10 and more particularly from 8-9; and
(c) the microcapsules are added as an aqueous slurry;
a hydrophilic clay being additionally added to the composition at at least one of these stages.

Although both components of the suspension agent are individually well known and individually used in aqueous compositions, it is a surprising feature that the combination permits a stable dispersion of capsules that will last for long storage times.

By “liquid detergent composition base” is meant the combination of all those ingredients, other than the suspending agent and the capsules that are used to make such compositions. These are well known to and widely used by the art, and include, but are not limited to, surfactants, co-builders, sequestrants of multivalent metal ions, enzymes, enzyme protection agents, anti-redeposition agents, thickening agents, organoleptics and specific additives. All of these materials are well known to the art, and all known types may be used in art-recognised proportions. Specific additives include neutralizers, auxiliary solvents, more specifically alcohols and glycols, sodium borate, rheology modifiers, suspension agents and thickeners, optical brightener, preservative agents and water.

The active-containing microcapsules for use in this composition may be selected from any of the many active-containing capsules known to the art. A particular type of microcapsule is the core-shell type, which essentially comprises a polymeric wall surrounding a core, which may be solid, part-solid or completely liquid. The nature of the polymeric wall is not narrowly critical, and non-limiting examples of suitable wall materials include crosslinked gelatine, aminoplast (urea- and melamine-formaldehyde) resins, polyureas, polyurethanes and acrylics. The nature of the core is entirely dependent on the nature of the active ingredient. In a typical case, it may be perfume and 100% liquid, but alternatively the core may be solid or waxy.

Examples of such capsules may be found in, the following documents, although it is emphasised that these represent only a small portion of the extensive literature relating to active-containing capsules: EP 0 385 534 and EP 1 407 753, International Publications WO 98/27261, WO 02/074430, WO 2004/016234 and WO 2006/056096, U.S. Pat. Nos. 3,516,941, 6,261,483, 6,045,835 and 6,106,875, and US publications 2004/115091 and 2007/149424.

However, the disclosure, while being described specifically with reference to core-shell capsules, is not restricted to this type, and other known types, such as cyclodextrin/perfume complexes, cellular capsules of, for example, polysaccharide (described in, for example, U.S. Pat. No. 3,971,852) and starch matrix capsules (described, for example, in U.S. Pat. No. 5,267,531) may also be used and are within the scope of this disclosure.

The hydrophilic clay for use in the product may be selected from the many natural or synthetic materials commercially available. Clays are typically fine-grained minerals, composed primarily of aluminium silicate and also containing iron, magnesium, alkali metals, alkaline earths, and others. The clay can be from different groups, examples including:
the kaolin group, which includes the minerals kaolinite, dickite, halloysite, and nacrite (polymorphs of Al₂Si₂O₅(OH)₄);
the smectite group, which includes dioctahedral smectites such as montmorillonite and nontronite and trioctahedral smectites for example saponite and those known as hectorites;
the illite group which includes the clay-micas; and
the chlorite group includes a wide variety of similar minerals with considerable chemical variation.

Clays used in this process can be pure or a mixture of different types of clay, along with other weathered minerals. Particular examples are montmorillonite clays.

The clay used in the process should have an average particle size of 100 μm maximum and more particularly 10 μm maximum. These sizes refer to clays present in the formulation. As dry clays prior to incorporation in the composition, the maximum average particle size is 600 μm, particularly from 200-300 μm.

The polymeric thickening agent, which is the other component of the suspending agent, is an alkali metal salt, particularly the sodium salt, of a polycarboxylic acid. Such materials are well known to the art and a large variety is readily available. They are anionic (meth)acrylate homopolymers and copolymers, particularly those with weight-average molecular weights of from 5,000-50,000. Aqueous emulsions of such polymers are sold as rheology modifiers, and typical, non-limiting examples include Carbopol Acqua™ 30, Carbopol EZ-4A™, Carbopol U20™; Acusol™ 820, Acusol™ 830, Acusol™ 835, Acusol™ 801S, Acusol™ 805 S, Acusol™ 823 S, Acusol™ 820 JB, Rheovis™ AT120, Arlypon™ TT, Rheocare™ TTA, Fortcryl™ ECL190, Fortcryl™ ECL196 and Fortcryl™ ECL290.

The proportions of hydrophilic clay and polymeric thickening agent required to achieve a stable dispersion of microcapsules will vary, depending on the nature of the materials used and the nature of the liquid detergent composition in which they are used. These proportions may be easily established by routine experimentation in every case. However, as a general guideline, the amount of the hydrophilic clay may vary from 0.05% to 5%, more particularly from 0.1 to 1% and from 0.3 to 0.5%, and the polymeric thickening agent or stabilizer may vary from 1 to 10%.

In a particular embodiment of the process, the microcapsules, clay and thickening agent are not added to a ready-made liquid detergent composition base, but are added at specific points in the preparation of such a base, such that the final result is a microcapsule-containing liquid detergent composition. There is therefore also provided a method of making a microcapsule-containing liquid detergent composition, comprising the incorporation of active-containing microcapsules in a liquid detergent composition base comprising detergent surfactants and other standard ingredients; by the steps of
(a) adding to water a polymeric thickening agent, which polymeric thickening agent is an alkali metal salt of a polycarboxylic acid;
(b) adding to the solution of (a) the detergent surfactants of the liquid detergent composition base;
(c) adjusting the pH to a value of from 7-11, particularly from 8-9; and
(d) adding the other standard ingredients of the liquid detergent composition base;
there being additionally added at any of the stages (a)-(d) an aqueous slurry of active-containing microcapsules and a hydrophilic clay.

In this procedure, the aqueous slurry of microcapsules and the clay may be added together or separately. In a particular embodiment, the clay is added to the water at stage (a), prior to the addition of the polymeric thickening agent. In a further particular embodiment, the aqueous slurry of microcapsules is added after the pH adjustment at (c). In a further embodiment, these two particular embodiments are both implemented.

The detergent surfactants may be any such surfactants suitable for the preparation of liquid detergents. Particular examples are linear alkylbenzene sulphonic acid comprising an alkyl hydrocarbon chain of from 11-13 carbon atoms, the surfactant having a pH value of less than 2 in water. Specific examples include, but are not limited to, sodium laureth sulphate and dodecyl acid linear alkyl benzene sulphonic acid. Both are well known and are commercially available from a number of suppliers.

As an example of the manufacturing procedure, water can be added as the first ingredient, followed by, in order, optical brightener, polymeric thickener, surfactants and alkali until a pH of from 7-11, particularly from 7-10, and more particularly from 8 to 9, is attained. After this, other surfactants, if required, are added following by any other desired additives as hereinabove described, such as anti-redepositant agent, sequestrants, enzymes and organoleptics. The clay may be added at any time during the procedure, more particularly at the end of the procedure, either alone as an aqueous clay dispersion or mixed with the active microcapsule slurry.

The resulting products contain microcapsules which are stably dispersed in the liquid preparation. It has the character of a pseudoplastic fluid. The capsules neither sink to the bottom nor float to the surface, but their distribution throughout the product is remarkably stable. In use, this means that materials treated with the products will receive a substantially constant proportion of capsules, regardless of whether the product has just been opened, or is nearly finished.

The disclosure is further described with reference to the following non-limiting examples, which depict particular embodiments, and in which all parts are expressed by weight.

### EXAMPLE 1

A liquid detergent composition is prepared as follows:

To 47.35 parts of water are added with stirring and in sequence and 5 parts of a polyacrylate rheology modifier (Rheocare™ TTA, ex BASF AG). To this mixture is then added 25 parts of sodium lauryl sulphate (Alkopon™ N ex Oxiteno) and 3.5 parts of a C10-13 linear alkyl benzene sulphonic acid (DetenLAS™ 320 ex Deten Quimica S.A., Brazil). This is followed by an addition of 3 parts of 85% triethanolamine, sufficient to give a pH of 8 to 9. There is then added 3 parts of a non-ionic surfactant (lauryl alcohol ethoxylated with 9 units of ethylene oxide (Ultrol™ L90, ex Oxiteno)).

To this basic formulation is further the following ingredients:

| | | |
|---|---|---|
| Propylene glycol | 4.0 | part |
| Anti-redepositant | 1.0 | part |
| Sodium citrate | 5.0 | part |
| Sodium borate | 0.5 | part |
| Enzymes | 1.0 | part |
| Preservative | 0.1 | part |
| Fragrance | 0.55 | part |
| Coloured pigment | 0.005 | part |

At the end 1 part of activated clay dispersion (CS Rheo 30 ex Chemical Service, Brazil) is added previously mixed with the active capsules or by itself.

The formulation is slightly viscous at room temperature around 2100 cP (Brookfield RVDV II, spindle 3, 20 rpm at 22° C.).

### EXAMPLE 2

0.5 parts of an activated clay (Optigel™ CK ex Sud-Chemie AG) is added to 63 parts of water with stirring. To this mixture is added 2 parts of a polyacrylate rheology modifier (Rheocare™ TTA, ex BASF AG) previously heated at 85° C., and the mixture is thoroughly stirred. 5 parts of linear alkyl benzene sulfonic acid (DetenLAS™ 320 ex Deten Quimica S.A., Brazil) previously heated at 75° C. is then added, followed by 16 parts of sodium lauryl sulphate (Texapon™ N 70 ex BASF AG) also previously heated to 65° C. 3 parts of propylene glycol and 3 parts of trisodium citrate dehydrate (33%) are then added. This is followed by an addition of 5 parts of 55° C. of fatty alcohol ethoxylate-AEO-7 (Dehydrol™ 2407 ex BASF AG). The mixture is cooled ito 40° C. and neutralized with sodium hydroxide (30%) and citric acid (50%) until pH 9. Preservative and perfume is added.

The formulation is slightly viscous at room temperature, around 2600 cP (Brookfield DV-III Ultra, LV2, 20 rpm and 27° C.)

### EXAMPLE 3

To the composition of Example 1 is added with gentle stirring 0.2% of a 40% (weight) slurry of fragrance-containing melamine-formaldehyde microcapsules, prepared as described in the examples of PCT publication WO 2008/098387. As a comparison, the same proportion of microcapsules is added to a commercially-available liquid detergent.

The two compositions are observed over a period of 12 weeks. It was found that, in the case of the commercial detergent, nearly all of the capsules had either sunk to the bottom or floated to the top after approximately 8 hours at room temperature. On the other hand, an estimated 90 to 100% of the microcapsules in the composition of Example 1 remained suspended in the detergent after 12 weeks at room temperature and at 37° C.

1. A liquid detergent composition, comprising a liquid detergent composition base and active-containing capsules of 200 μm diameter maximum, characterised in that the base has a pH of from 7-10 and additionally contains a suspension agent, which comprises a combination of a hydrophilic clay and a polymeric thickening agent, which thickening agent is an alkali metal salt of a polycarboxylic acid.

2. The liquid detergent composition according to claim 1, in which the clay is a montmorillonite clay.

3. The liquid detergent composition according to claim 1, in which the clay has an average particle size of 100 μm maximum.

4. The liquid detergent composition according to claim 1, in which the polymeric thickening agent is selected from the group of anionic (meth)acrylate homopolymers and copolymers.

5. The liquid detergent composition according to claim 1, in which the amount of the hydrophilic clay is from 0.05% to 1%, and the polymeric thickening agent is from 1 to 10% by weight of the total composition.

6. A method of making a microcapsule-containing liquid detergent composition, comprising the addition to a liquid detergent base of active-containing microcapsules; characterised in that
(a) there is first added to the base a polymeric thickening agent, which polymeric thickening agent is an alkali metal salt of a polycarboxylic acid;
(b) the pH is adjusted to a value of from 7-10; and
(c) the microcapsules are added as an aqueous slurry;
a hydrophilic clay being additionally added to the composition at at least one of these stages.

7. The method according to claim 6, in which the clay is added at stage (c).

8. A method of making a microcapsule-containing liquid detergent composition, comprising the incorporation of active-containing microcapsules in a liquid detergent composition base comprising detergent surfactants and other standard ingredients; by the steps of
(a) adding to water a polymeric thickening agent, which polymeric thickening agent is an alkali metal salt of a polycarboxylic acid;
(b) adding to the solution of (a) the detergent surfactants of the liquid detergent composition base;
(c) adjusting the pH to a value of from 7-11; and
(d) adding the other standard ingredients of the liquid detergent composition base;
there being additionally added at any of the stages (a)-(d) an aqueous slurry of active-containing microcapsules and a hydrophilic clay.

9. The method according to claim 8, in which the hydrophilic clay is added to the water at stage (a), prior to the addition of the polymeric thickening agent.

10. The method according to claim 8, in which the aqueous slurry of active-containing microcapsules is added after the pH adjustment of stage (c).

11. The method according to claim 9, in which the aqueous slurry of active-containing microcapsules is added after the pH adjustment of stage (c).

12. The method according to claim 8 comprising adjusting the pH to a value of from 7-10 at stage (c).

13. The method according to claim 8 comprising adjusting the pH to a value of from 8-9 at stage (c).

14. The liquid detergent composition according to claim 1, in which the clay has an average particle size of 10 μm maximum.

15. The liquid detergent composition according to claim 1, in which the amount of the hydrophilic clay is from 0.3 to 0.5% by weight of the total composition.

16. The liquid detergent composition according to claim 1, in which the amount of the polymeric thickening agent is from 1 to 6% by weight of the total composition.
